(19) United States
(12) Patent Application Publication
(10) Pub. No.: US 2011/0102264 A1
(43) Pub. Date: May 5, 2011

(54) APPARATUS AND METHOD FOR DETECTING INTERIOR POSITION USING DIGITAL BROADCASTING SIGNAL

(75) Inventors: Cheon Sig Sig SIN, Daejeon (KR); Ho Jin Lee, Daejeon (KR)

(73) Assignee: ELECTRONICS AND TELECOMMUNICATIONS RESEARCH INSTITUTE, Daejeon-City (KR)

(21) Appl. No.: 12/938,721

(22) Filed: Nov. 3, 2010

(30) Foreign Application Priority Data
Nov. 4, 2009 (KR) 10-2009-0105924
Sep. 10, 2010 (KR) 10-2010-0088999

(51) Int. Cl. G01S 1/08

(52) U.S. Cl. 342/386; 342/464; 342/451

(57) ABSTRACT

Provided is a receiving apparatus for detecting an interior position using digital broadcasting signals includes: a receiving unit receiving a digital broadcasting signal, which includes navigation information used for determining a position of the receiving apparatus, transmitted from a digital broadcasting signal transmitting apparatus; and an output unit outputting a signal to outside the receiving apparatus via wireless communication, wherein the receiving unit receives the digital broadcasting signals from a plurality of the digital broadcasting signal transmitting apparatuses.

### CROSS-REFERENCE TO RELATED APPLICATIONS

This application claims priority under 35 U.S.C. §119 to Korean Patent Application No. 10-2009-0105924, filed on Nov. 4, 2009, and No. 10-2010-0088999, filed on Sep. 10, 2010, in the Korean Intellectual Property Office, the disclosure of which is incorporated herein by reference in its entirety.

### TECHNICAL FIELD

The present invention relates to an apparatus and a method for detecting an interior position, and more particularly, to an apparatus and a method for detecting an interior position using digital broadcasting signals having stronger signal intensity than that of navigation signals.

### BACKGROUND

In general, position information is obtained by receiving microwaves from a navigation satellite such as a global positioning system (GPS) using a satellite navigation receiver to determine position vectors of the receiver. As the user position information in a building or a shielded area is calculated by the above method, it is difficult to secure the visibility of the navigation satellite and it is difficult to accurately calculate the position information due to a weak signal level required for the satellite navigation receiver to process signals.

In order to solve the problem, a pseudolite has been widely used. In a system using pseudolites, a plurality of pseudolites transmitting the same signals as those transmitted by the GPS satellite, a base station generating correction information (mainly time correction information) by monitoring the satellite signals, and a wireless link to transmit the generated correction information to the receiver of the user are required. As an example of upgraded method, there has been proposed a system of mounting a precise time source in a master pseudolite among several pseudolites, instead of having a wireless link for providing correction information to a user receiver, monitoring times of a plurality of slave pseudolites at the pseudolite signal monitoring base station, and then, performing synchronization by PLL controllers installed in the slave pseudolites based on the monitored time.

Another technology of detecting an interior position uses the digital TV signals. In this case, apparatuses such as a monitoring station monitoring the state of the digital TV signals, a transmitter transmitting the digital TV signals, a base station, and a digital TV location server, etc., are additionally required.

### SUMMARY

The present invention provides an apparatus and a method for detecting an interior position using digital broadcasting signals.

According to an aspect of the present invention, there is provided a receiving apparatus for detecting an interior position using digital broadcasting signals, comprising: a receiving unit receiving a digital broadcasting signal, which includes navigation information used for determining a position of the receiving apparatus, transmitted from a digital broadcasting signal transmitting apparatus; and an output unit outputting a signal to outside the receiving apparatus via wireless communication, wherein the receiving unit receives the digital broadcasting signals from a plurality of the digital broadcasting signal transmitting apparatuses.

The receiving apparatus may further comprises a noise removal and signal amplifying unit for removing noise from a received signal and amplifying the received signal, wherein the output unit outputs a signal from the noise removal and signal amplifying unit.

It is preferable that the receiving unit receives clock information together with the digital broadcasting signal from the digital broadcasting signal transmitting apparatus.

The output unit may output the digital broadcasting signal to a processing apparatus outside the receiving apparatus; and the receiving unit may receive position information of the receiving apparatus, which is determined using the navigation information included in the digital broadcasting signal, from the processing apparatus.

The receiving apparatus may further comprises: a navigation information extraction unit for extracting the navigation information from the received digital broadcasting signal, wherein the output unit outputs the navigation information to a processing apparatus outside the receiving apparatus; and wherein the receiving unit receives a position information of the receiving apparatus determined using the navigation information from the processing apparatus.

Or, the receiving apparatus of claim further comprises: a navigation information extraction unit for extracting the navigation information from the received digital broadcasting signal; and a position determination unit for calculating a pseudorange between the digital broadcasting signal transmitting apparatus and the receiving apparatus using the extracted navigation information and determining a position of the receiving apparatus based on the pseudorange.

It is preferable that the receiving unit receives the digital broadcasting signals from four or more of the digital broadcasting signal transmitting apparatuses.

According to another aspect of the present invention, a method for detecting an interior position using digital broadcasting signals comprises: receiving digital broadcasting signals including navigation information used for determining a position of a receiving apparatus from a plurality of digital broadcasting signal transmitting apparatuses; extracting the navigation information from the received digital broadcasting signals; calculating pseudoranges between the digital broadcasting signal transmitting apparatuses and the receiving apparatus using the extracted navigation information; and determining a position of the receiving apparatus based on the calculated pseudoranges.

According to yet another aspect of the present invention, a system for detecting an interior position using digital broadcasting signals comprises: a plurality of digital broadcasting signal transmitting apparatuses, each of which includes a GPS receiving module and a clock module; a receiving apparatus for receiving digital broadcasting signals including GPS navigation information from the digital broadcasting signal transmitting apparatuses; and a processing apparatus for calculating pseudoranges between the digital broadcasting signal transmitting apparatuses and the receiving apparatus using the navigation information transmitted in the digital broadcasting signals and determining a position of the receiving apparatus based on the pseudoranges.

The processing apparatus may receive the digital broadcasting signals from the receiving apparatus via wireless communication.

The processing apparatus may comprises: a local server for receiving the digital broadcasting signals from the receiving apparatus and extracting navigation information which is transmitted in the digital broadcasting signal; and a central processing apparatus for receiving the navigation information extracted from the local server, calculating pseudoranges between the digital broadcasting signal transmitting apparatuses and the receiving apparatus, and determining a position of the receiving apparatus based on the pseudoranges.

It is preferable that the local server transmits the navigation information to the central processing apparatus via wired or wireless Internet.

Other features and aspects will be apparent from the following detailed description, the drawings, and the claims.

### BRIEF DESCRIPTION OF THE DRAWINGS

FIG. 1 is a block diagram showing a schematic configuration of a system for detecting an interior position according to an exemplary embodiment of the present invention;

FIG. 2 is a block diagram showing a schematic configuration of a receiving apparatus included in a system for detecting an interior position according to an exemplary embodiment of the present invention;

FIGS. 3 and 4 are block diagrams showing schematic configurations of receiving apparatuses according to another exemplary embodiments of the present invention, respectively; and

FIG. 5 is a flow chart showing a method for detecting an interior position according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, an apparatus and method for detecting an interior position according to an exemplary embodiment of the present invention will be described in detail with reference to the accompanying drawings.

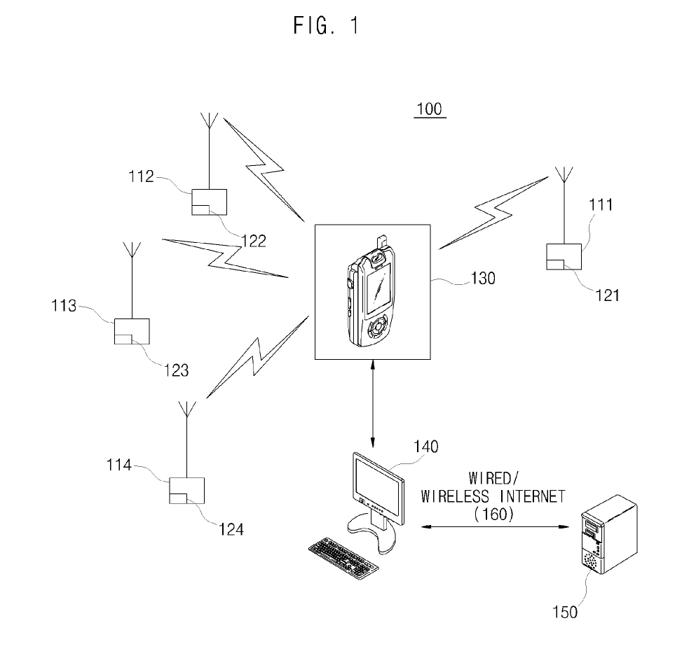

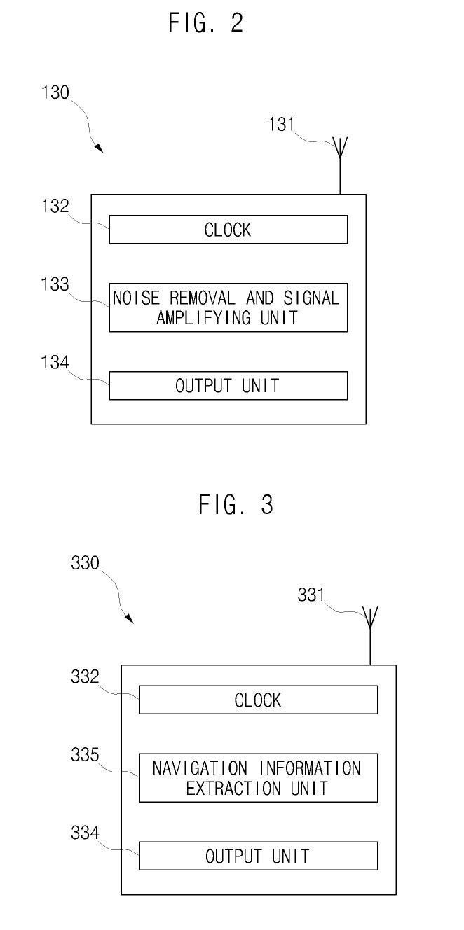

FIG. 1 is a block diagram showing a schematic configuration of a system for detecting an interior position according to an exemplary embodiment of the present invention and FIG. 2 is a diagram showing a configuration of a receiving apparatus in the system of FIG. 1.

The system for detecting an interior position according to an exemplary embodiment of the present invention transmits navigation signals to a receiving apparatus, together with digital multimedia broadcasting signals, by using four or more digital multimedia broadcasting signal transmitting apparatuses, each of which includes a GPS chip or a GPS receiver.

As shown in FIG. 1, a system 100 for detecting an interior position according to an exemplary embodiment of the present invention includes four digital multimedia broadcasting signal transmitting apparatuses 111, 112, 113, and 114 attached with a GPS chip or a GPS receiver. Although FIG. 1 shows four digital multimedia broadcasting signal transmitting systems 111, 112, 113, and 114, five or more digital multimedia broadcasting signal transmitting systems may be used.

Each of the digital multimedia broadcasting signal transmitting apparatuses 111, 112, 113, and 114 includes clock modules 121, 122, 123, and 124 that distribute precise clock information necessary to synchronize between the digital multimedia broadcasting signal transmitting apparatuses 111, 112, 113, and 114.

The system 100 for detecting an interior position according to the exemplary embodiment of the present invention is also configured to include a receiving apparatus 130 that includes a monitoring function collecting information (timing for the digital multimedia broadcasting signal, channel information used in the corresponding area, or the like) on the digital multimedia broadcasting signals, a local server 140 that processes information collected in the receiving apparatus including the monitoring function, a central processing apparatus 150 that searches the optimal digital multimedia broadcasting signals and calculates pseudoranges, and a wired/wireless internet network 160 that communicates between the local server and the central processing apparatus.

The digital multimedia broadcasting signal transmitting apparatuses 111, 112, 113, and 114 transmits signals used for transmission of the existing digital multimedia broadcasting programs. In addition, the clock modules 121, 122, 123, and 124 mounted in digital multimedia broadcasting signal transmitting apparatuses 111, 112, 113, and 114 can also be the ones already mounted in the currently built digital multimedia broadcasting signal transmitting apparatus as they are.

The GPS satellite continuously broadcasts navigation information including state information of the satellite, time and error of a clock mounted in the satellite, orbit information and almanac, ephemeris, coefficients for correcting error, etc., at a rate of 50 bps, wherein each of the digital multimedia broadcasting signal transmitting apparatuses 111, 112, 113, and 114 receives the information through the GPS receiver to transmit it together with the digital multimedia broadcasting signals.

The receiving apparatus 130 includes a monitoring function that receives signals transmitted from the digital multimedia broadcasting signal transmitting apparatuses 111, 112, 113, and 114 to collect the information on the digital multimedia broadcasting signals (timing for the digital multimedia broadcasting signal, channel information used in the corresponding area, or the like).

The receiving apparatus 130 receives signals transmitted from the digital multimedia broadcasting signal transmitting apparatuses 111, 112, 113, and 114 similar to the GPS receiver to determine the positions of the digital multimedia broadcasting signal transmitting apparatuses 111, 112, 113, and 114 and the receiving apparatus 130. When the time difference between the signals transmitted from the digital multimedia broadcasting signal transmitting apparatuses 111, 112, 113, and 114 and the signals received from the receiving apparatus 130 is measured, the distance between the digital multimedia broadcasting signal transmitting apparatuses 111, 112, 113, and 114 and the receiving apparatus 130 can be obtained. The transmitted signals include the information on the positions of the digital multimedia broadcasting signal transmitting apparatuses 111, 112, 113, and 114. When the distances to at least three digital multimedia broadcasting signal transmitting apparatuses and the positions of each transmitting apparatus are known, the position of the receiving apparatus 130 may be calculated using the trilateration method. However, since clocks are not completely accurate, the positions are generally determined using four or more satellites in the GPS system in order to correct errors. The system 100 for detecting an interior position according to the exemplary embodiment of the present invention similarly determines the position using four (or more) digital multimedia broadcasting signal transmitting apparatuses 111, 112, 113, and 114.

As shown in FIG. 2, the receiving apparatus 130 may include an antenna, which is a receiving unit 131 tuned to a frequency transmitted from the digital multimedia broadcasting signal transmitting apparatuses 111, 112, 113, and 114, a precise clock 132 using a crystal oscillator, or the like, an output unit 134 for outputting the received signals to the local server 140. In addition, a noise removing and signal amplifying unit 133 for removing noise from the received signals and amplifying the signals may be included. The output unit 134 may output signals to the local server 140 via wireless communication.

In addition, the receiving apparatus 130 may further include a communication unit (not shown) for transmitting and receiving observation results with other receiving apparatuses, if necessary. This is suitable for the case of using a relative positioning scheme in order to increase the accuracy of positioning.

The information collected by the receiving apparatus 130 is transmitted to the local server 140.

The local server 140 extracts the navigation information included in the digital multimedia broadcasting signals transmitted from the receiving apparatus 130 and transmits the navigation information to the central processing apparatus 150 via wired or wireless Internet 160.

The central processing apparatus 150 uses the information received from the local server 140 to search the optimal digital multimedia broadcasting signals and calculate the pseudoranges.

The most probable value of the position of the receiving apparatus 130 is obtained by correcting and overlapping the errors for the pseudoranges from the receiving apparatus 130 to four digital multimedia broadcasting signal transmitting apparatuses 111, 112, 113, and 114. However, the distance obtained as described is not a real range, but a pseudorange, due to the errors caused by the real propagating path, the errors of the clocks embedded in the transmitting apparatuses and the receiving apparatus, the errors generated in the internal circuit of the receiving apparatus, etc. The navigation messages are included in the signals received from the GPS. The pseudorange may be corrected using various coefficients included in the navigation messages, such that the position of the receiving apparatus 130 may be finally determined.

In the embodiment described above, the receiving apparatus 130 transmits the signals received from the digital multimedia broadcasting signal transmitting apparatuses 111, 112, 113, and 114, and the local server 140 extracts the navigation information included in the digital multimedia broadcasting signals. However, the receiving apparatus 130 itself may include a navigation information extraction unit.

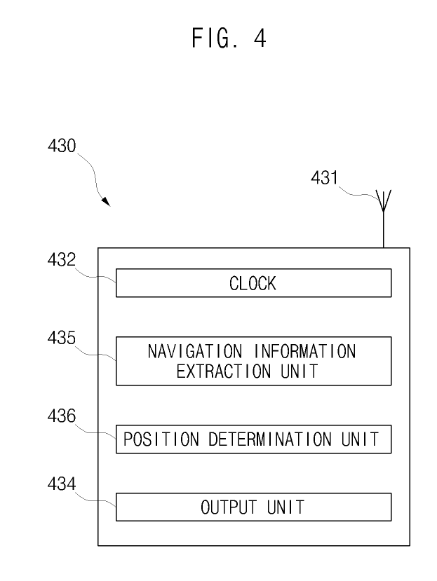

FIG. 3 shows a receiving apparatus according to another embodiment of the present invention.

As shown in FIG. 3, a receiving apparatus 330 includes a navigation information extraction unit 335, as well as a receiving unit 331, a clock 332, and an output unit 334, to extract navigation information from the received signals from the digital multimedia broadcasting signal transmitting apparatuses and transmit the extracted navigation information to the local server or the central processing apparatus directly.

In addition, the receiving apparatus may have both the navigation information extraction unit and a position determination unit to perform a position determination function by itself.

FIG. 4 shows a receiving apparatus according to yet another embodiment of the present invention.

As shown in FIG. 4, a receiving apparatus 430 includes a receiving unit 431, a clock 432, an output unit 434, a navigation information extraction unit 435, and a position determination unit 436. Thus, the receiving apparatus 430 extracts navigation information from the received signals from the digital multimedia broadcasting signal transmitting apparatuses by the navigation information extraction unit 435 and determines a position of the receiving apparatus 430 based on pseudoranges to the digital multimedia broadcasting signal transmitting apparatuses calculated from the extracted navigation information by the position determination unit 436.

According to the embodiment described with reference to FIGS. 1 and 2, the local server 140 extracts the navigation information included in the digital multimedia broadcasting signals and transmits the extracted navigation information to the central processing apparatus 150, and the central processing apparatus 150 calculates the pseudoranges and determines the position. However, the local server may perform the extraction of the navigation information, calculation of the pseudoranges, and determination of the position.

As yet another embodiment, the central processing unit may extract the navigation information, calculate the pseudoranges, and determine the position without having the local server shown in FIG. 1. If this is the case, the receiving apparatus transmits the signal received from the digital multimedia broadcasting signal transmitting apparatuses to the central processing apparatus directly.

That is, different functions performed by the receiving apparatus 130, local server 140, and central processing apparatus 150 as shown in FIG. 1 can be distributed in many different ways as needed.

A method for detecting an interior position using the apparatus for detecting an interior position will now be described with reference to FIG. 2.

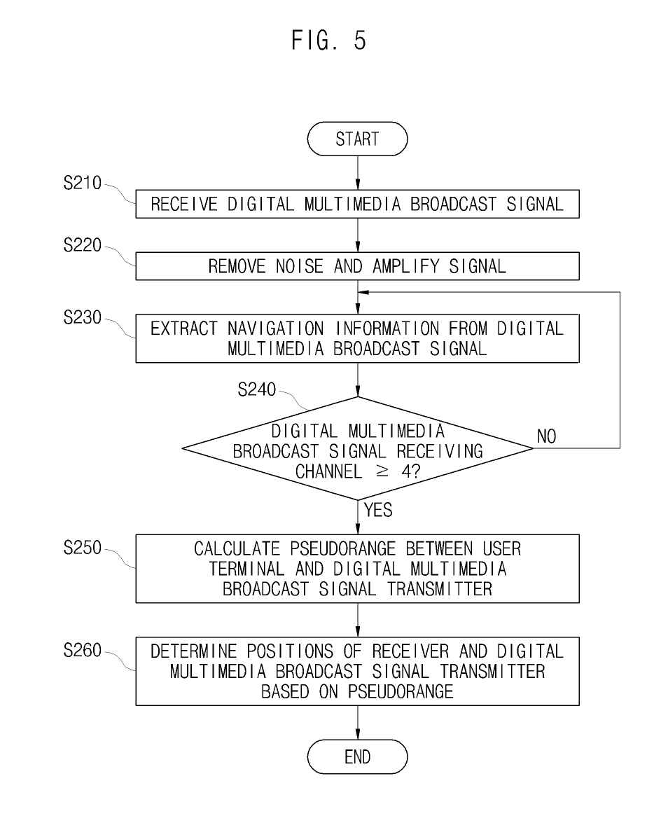

Now, a method for detecting an interior position according to an exemplary embodiment of the present invention is described in detail with reference to FIG. 5. In the following, a method for detecting an interior position using the system shown in FIG. 1 will be described.

FIG. 5 is a flow chart showing a method for detecting an interior position according to an exemplary embodiment of the present invention. As shown in FIG. 5, the receiving apparatus 130 receives the digital multimedia broadcasting signals transmitted from the digital multimedia broadcasting signal transmitting apparatuses 111, 112, 113, and 114 (S210). The transmitting apparatuses 111, 112, 113, and 114 transmit signals including clock information required for clock synchronization between the transmitting apparatuses 111, 112, 113, and 114, which are generated by clock modules 121, 122, 123, and 124. Therefore, the receiving apparatus 130 collects timing information for the digital multimedia broadcasting signals, digital multimedia broadcasting signal channel information used in the corresponding area, or the like.

Further, the receiving apparatus 130 may compensate for the deterioration in signals generated in various paths for the received digital multimedia broadcasting signals and perform the noise removal (S220).

The information received in the receiving apparatus 130 is transmitted to the local server 140, which extracts the navigation information included and transmitted in the digital multimedia broadcasting signals (S230).

The local server 140 determines whether the number of received digital multimedia broadcasting channels is four or more (S240).

When the digital multimedia broadcasting signals are received from four or more broadcasting channels, the extracted navigation information is transmitted to the central processing apparatus 150 through wired or wireless Internet 160 to calculate the pseudorange between the receiving apparatus 130 and the digital multimedia broadcasting signal transmitting apparatuses 111, 112, 113, and 114 in the central processing apparatus 150 (S250).

Next, the position of the receiving apparatus 130 and the positions of the digital multimedia broadcasting signal transmitting apparatuses 111, 112, 113, and 114 may be determined based on the pseudoranges between the receiving apparatus 130 and the digital multimedia broadcasting signal transmitting apparatuses 111, 112, 113, and 114, which are calculated at step S250.

Though a method for detecting an interior position using the system as shown in FIG. 1 is described, it will be understood that methods for detecting an interior position using the apparatuses shown in FIG. 3 or 4, or other embodiments, which are not explicitly shown. For example, in the embodiment shown in FIG. 4, in which the receiving apparatus includes the navigation information extraction unit and the processing unit, an interior position is detected through similar steps shown in FIG. 5 except that the performing subject becomes the receiving apparatus, and the process of transmitting information between the receiving apparatus, local server, and the central processing apparatus.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A receiving apparatus for detecting an interior position using digital broadcasting signals, comprising:
a receiving unit receiving a digital broadcasting signal, which includes navigation information used for determining a position of the receiving apparatus, transmitted from a digital broadcasting signal transmitting apparatus; and
an output unit outputting a signal to outside the receiving apparatus via wireless communication;
wherein the receiving unit receives the digital broadcasting signals from a plurality of the digital broadcasting signal transmitting apparatuses.

2. The apparatus of claim 1, further comprising a noise removal and signal amplifying unit for removing noise from a received signal and amplifying the received signal,
wherein the output unit outputs a signal from the noise removal and signal amplifying unit.

3. The apparatus of claim 1, wherein the receiving unit receives clock information together with the digital broadcasting signal from the digital broadcasting signal transmitting apparatus.

4. The apparatus of claim 1, wherein:
the output unit outputs the digital broadcasting signal to a processing apparatus outside the receiving apparatus; and
the receiving unit receives position information of the receiving apparatus, which is determined using the navigation information included in the digital broadcasting signal, from the processing apparatus.

5. The apparatus of claim 1, further comprising a navigation information extraction unit for extracting the navigation information from the received digital broadcasting signal,
wherein the output unit outputs the navigation information to a processing apparatus outside the receiving apparatus; and
wherein the receiving unit receives a position information of the receiving apparatus determined using the navigation information from the processing apparatus.

6. The apparatus of claim 1, further comprising:
a navigation information extraction unit for extracting the navigation information from the received digital broadcasting signal; and
a position determination unit for calculating a pseudorange between the digital broadcasting signal transmitting apparatus and the receiving apparatus using the extracted navigation information and determining a position of the receiving apparatus based on the pseudorange.

7. The apparatus of claim 1, wherein the receiving unit receives the digital broadcasting signals from four or more of the digital broadcasting signal transmitting apparatuses.

8. A method for detecting an interior position using digital broadcasting signals, comprising:
receiving digital broadcasting signals including navigation information used for determining a position of a receiving apparatus from a plurality of digital broadcasting signal transmitting apparatuses;
extracting the navigation information from the received digital broadcasting signals;
calculating pseudoranges between the digital broadcasting signal transmitting apparatuses and the receiving apparatus using the extracted navigation information; and
determining a position of the receiving apparatus based on the calculated pseudoranges.

9. The method of claim 8, wherein the receiving receives clock information for synchronizing each digital broadcasting signal transmitting apparatus from the digital broadcasting signal transmitting apparatuses, together with the digital broadcasting signals.

10. The method of claim 8, further comprising, after the receiving, removing noise from the received digital broadcasting signals and amplifying the digital broadcasting signals.

11. The method of claim 8, wherein the calculating is performed when the number of broadcasting channels of the received digital broadcasting signals is four or more.

12. A system for detecting an interior position using digital broadcasting signals, comprising:
a plurality of digital broadcasting signal transmitting apparatuses, each of which includes a GPS receiving module and a clock module;
a receiving apparatus for receiving digital broadcasting signals including GPS navigation information from the digital broadcasting signal transmitting apparatuses; and
a processing apparatus for calculating pseudoranges between the digital broadcasting signal transmitting apparatuses and the receiving apparatus using the navigation information transmitted in the digital broadcasting signals and determining a position of the receiving apparatus based on the pseudoranges.

13. The system of claim 12, wherein the digital broadcasting signal transmitting apparatus transmits a clock information generated by the clock module together with the digital broadcasting signal.

14. The system of claim 12, wherein the receiving apparatus comprises:
a receiving unit receiving a signal transmitted from the digital broadcasting signal transmitting apparatus;
a noise removal and signal amplifying unit for removing noise from the received signal and amplifying the received signal; and
an output unit outputting a signal from the noise removal and signal amplifying unit to outside the receiving apparatus.

15. The system of claim 12, wherein the receiving apparatus receives the digital broadcasting signals from four or more of the digital broadcasting signal transmitting apparatuses.

16. The system of claim 12, wherein the processing apparatus receives the digital broadcasting signals from the receiving apparatus via wireless communication.

17. The system of claim 12, wherein the processing apparatus comprises:
a local server for receiving the digital broadcasting signals from the receiving apparatus and extracting navigation information which is transmitted in the digital broadcasting signal; and
a central processing apparatus for receiving the navigation information extracted from the local server, calculating pseudoranges between the digital broadcasting signal transmitting apparatuses and the receiving apparatus, and determining a position of the receiving apparatus based on the pseudoranges.

18. The system of claim 17, wherein the local server transmits the navigation information to the central processing apparatus via wired or wireless Internet.
